(19) United States
(12) Patent Application Publication
(10) Pub. No.: US 2014/0338643 A1
(43) Pub. Date: Nov. 20, 2014

(54) SYSTEM AND METHOD FOR COOLING OF AN EXHAUST GAS RECIRCULATION UNIT

(71) Applicant: Caterpillar Inc., Peoria, IL (US)

(72) Inventors: Vivek Sundararaj, Peoria, IL (US); Scott R. Schuricht, Edwards, IL (US); David Allen Akers, Morton, IL (US)

(73) Assignee: Caterpillar Inc., Peoria, IL (US)

(21) Appl. No.: 13/894,633

(22) Filed: May 15, 2013

(51) Int. Cl. F02M 25/07

(52) U.S. Cl. CPC F02M 25/0737
USPC 123/568.12

(57) ABSTRACT

A heat exchanger for an exhaust gas recirculation unit is provided. A tube core of the heat exchanger includes a plurality of coolant channels disposed between a plurality of exhaust gas tubes extending from an upstream face to a downstream face. A coolant inlet line and a first coolant outlet line is disposed in a first quarter section of the tube core defined between the upstream face and one fourth of a length of the tube core adjacent to the upstream face. The first coolant outlet line is configured to draw at least a portion of a coolant flow across the upstream face and into the first coolant outlet line. Further, a second coolant outlet line is provided and is configured to discharge a remaining portion of the coolant flow from the plurality of coolant channels that was not drawn out of the first coolant outlet line.

### TECHNICAL FIELD

The present disclosure relates to an exhaust gas recirculation unit, and more particularly to a system and method for cooling the exhaust gas recirculation unit.

### BACKGROUND

An exhaust gas recirculation (EGR) cooler is a component associated with an engine which is generally installed in order to meet emission level requirements. In some applications, the EGR cooler may be subjected to high thermal cycle stress, specifically at an exhaust inlet face of the EGR cooler which may be brought in contact with a heated exhaust gas flow received from an exhaust manifold of the engine. This high thermal stress may lead to premature failure of the EGR cooler.

Several EGR cooler designs are known in the art. For example, U.S. Publication No. 2010/0025023 (hereinafter “the '023 publication) discloses a three-chambered EGR cooler accommodating an EGR flow, a first coolant flow and a second coolant flow isolated from the first coolant flow. However, the '023 publication does not address concerns with EGR cooler failure due to high thermal loads at an inlet face thereof.

Hence, there is a need for an improved design of the EGR cooler to overcome the above mentioned shortcomings.

### SUMMARY OF THE DISCLOSURE

In one aspect of the present disclosure a heat exchanger for an exhaust gas recirculation unit is provided. The heat exchanger comprises a tube core including a plurality of exhaust gas tubes extending from an upstream face to a downstream face. The tube core further includes a plurality of coolant channels disposed between the plurality of exhaust gas tubes. The heat exchanger further includes a coolant inlet line connected to the plurality of coolant channels and disposed in a first quarter section of the tube core defined between the upstream face and one fourth of a length of the tube core adjacent to the upstream face. A first coolant outlet line is connected to the plurality of coolant channels and disposed in the first quarter section. The first coolant outlet line is configured to draw at least a portion of a coolant flow across the upstream face and into the first coolant outlet line. Further, a second coolant outlet line is connected to the plurality of coolant channels and disposed downstream of the first coolant outlet line with relation to a direction of the coolant flow. The second coolant outlet line is configured to discharge a remaining portion of the coolant flow from the plurality of coolant channels that was not drawn out of the first coolant outlet line.

In another aspect, an engine having an exhaust gas recirculation loop and a single coolant loop is provided. The exhaust gas recirculation loop includes an exhaust gas inlet and an exhaust gas outlet. The exhaust gas inlet is provided at an upstream face of a tube core. The exhaust gas inlet is configured to receive an exhaust gas flow into a plurality of exhaust gas tubes of the tube core. Further, the exhaust gas outlet is provided at a downstream face of the tube core and positioned downstream of the exhaust gas inlet with relation to a direction of the exhaust gas flow. The exhaust gas outlet is configured to discharge the exhaust gas flow from the plurality of exhaust gas tubes. The single coolant loop includes a coolant inlet line, a first coolant outlet line and a second coolant outlet line. The coolant inlet line is connected to a plurality of coolant channels disposed between the plurality of exhaust gas tubes. The coolant inlet line is provided in a first quarter section of the tube core defined between the upstream face and one fourth of a length of the tube core adjacent to the upstream face. The coolant inlet line is configured to introduce a coolant flow into the plurality of coolant channels. The first coolant outlet line is connected to the plurality of coolant channels and disposed in the first quarter section. The first coolant outlet line is configured to draw at least a portion of the coolant flow into the first coolant outlet line across the exhaust gas inlet. The second coolant outlet line is connected to the plurality of coolant channels. The second coolant outlet line is configured to discharge a remaining portion of the coolant flow from the plurality of coolant channels that was not drawn into the first coolant outlet line.

In yet another aspect a method for cooling an exhaust gas flow in an exhaust gas recirculation unit is provided. The method receives the exhaust gas flow at an upstream face of the exhaust gas recirculation unit. The method introduces a coolant flow into the exhaust gas recirculation unit. Further, the method draws at least a portion of the coolant flow across the upstream face and into a first coolant outlet line disposed partway along a length of the exhaust gas recirculation unit. Additionally, the method discharges a remaining portion of the coolant flow from the exhaust gas recirculation unit through a second coolant outlet line that was not drawn into the first coolant outlet line.

Other features and aspects of this disclosure will be apparent from the following description and the accompanying drawings.

### BRIEF DESCRIPTION OF THE DRAWINGS

FIG. 1 is a schematic diagram of an engine installed on an exemplary machine, according to one embodiment of the present disclosure;

FIG. 2 is a perspective view of a heat exchanger for an exhaust gas recirculation unit having a first coolant outlet line;

FIGS. 3A and 3B are schematic representations of variations in a thermal pattern produced at an upstream face of the heat exchanger corresponding to absence and presence of the first coolant outlet line respectively; and

FIG. 4 is a flowchart of a method for cooling an exhaust gas flow within the exhaust gas recirculation unit.

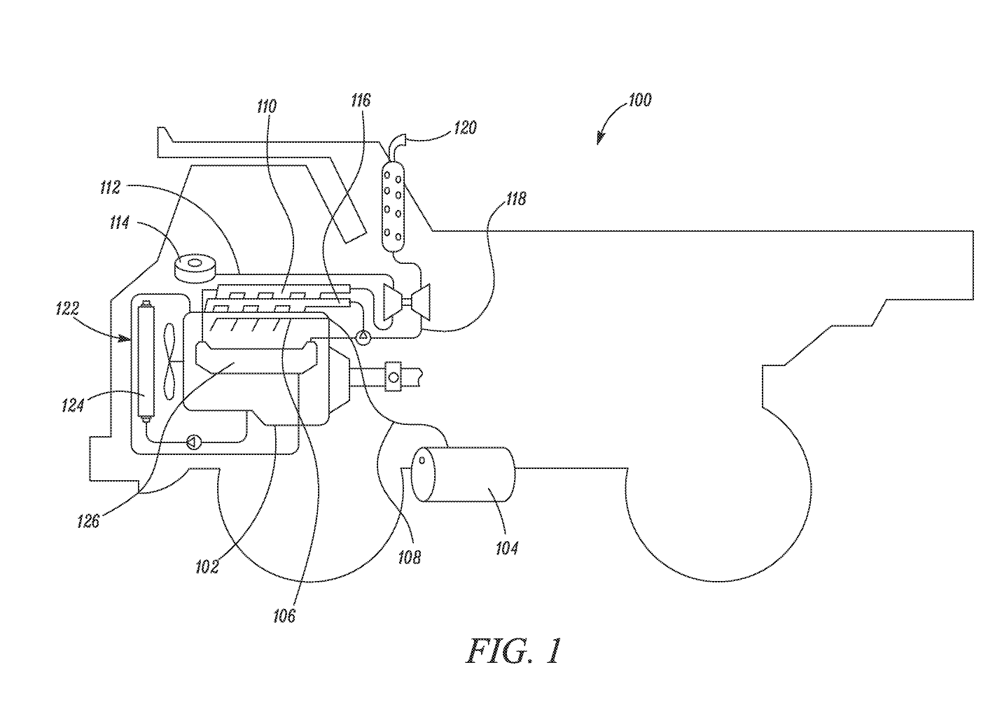

### DETAILED DESCRIPTION

Wherever possible, the same reference numbers will be used throughout the drawings to refer to the same or the like parts. FIG. 1 illustrates an exemplary machine 100, according to one embodiment of the present disclosure. The machine 100 illustrated in the accompanying figures is a dump truck. It should be noted that the machine 100 may be any “over-the-road” vehicle such as a truck used in transportation. Further, the machine 100 may embody any other type of machine 100 that performs an operation associated with an industry such as mining, construction, farming, transportation, or any other industry known in the art. For example, the machine 100 may be an off-highway truck, an earth-moving machine, such as a wheel loader, an excavator, a dump truck, a backhoe, a motor grader, a material handler, marine equipment, or the like. In one embodiment, the term “machine” used herein may be used to refer to stationary equipment, like a generator, that may be driven by an engine to generate electricity.

The machine 100 may be powered by an engine 102 which is adapted to combust a fuel to release the chemical energy therein and convert that energy to mechanical power. The engine 102 may be a compression ignition engine that combusts diesel fuel. Alternatively, the engine 102 may include a spark ignition engine that is configured to combust gasoline or other fuels such as ethanol, bio-fuels, or the like.

Further, in order to store and supply the engine 102 with fuel for the combustion process, the machine 100 may additionally include a fuel reservoir 104 in fluid communication with a fuel rail 106 on the machine 100 by way of a fuel line 108. An intake manifold 110 may be disposed over the engine 102 and in fluid communication with a plurality of combustion chambers in association with the engine 102, in order to direct intake air used in the combustion process to the engine 102. The intake manifold 110 may be configured to receive intake air from an intake line 112. The intake line 112 in turn may draw atmospheric air through an air intake filter 114.

Further, an exhaust manifold 116 may extend over the engine 102 and be in fluid communication with the plurality of combustion chambers. It should be noted that the arrangement of the intake manifold 110 and the exhaust manifold 116 may vary based on the application. Further, the exhaust gases flowing through the exhaust manifold 116 may be directed to an exhaust line 118 and released into the atmosphere via an exhaust orifice 120.

During operation, the engine 102 may get heated. Accordingly, a coolant system 122 may be connected to the engine 102 for removing the heat produced by the engine 102 and facilitating cooling of the engine 102. The coolant system 122 may include a radiator 124 in fluid communication with the engine 102, in order to dissipate heat from a coolant leaving the engine 102. Further, the relatively cooled coolant leaving the radiator 124 may be returned to the engine 102. A person of ordinary skill in the art will appreciate that any known heat exchanger may be utilized as the radiator 124. It should be understood that the connections formed between the various components described herein is exemplary. The system may include other components without deviating from the scope of the present disclosure.

Additionally, an exhaust gas recirculation (EGR) loop may be associated with the engine 102 for reducing the emissions produced by the combustion process. More specifically, the EGR loop may include necessary passageways fluidly connecting an EGR unit 126 to the exhaust manifold 116 and the intake manifold 110 of the engine 102 respectively. The EGR unit 126 may be configured to redirect at least a portion of the exhaust gas flow discharged from the combustion process back into the intake manifold 110 for intermixing with the intake air. One of ordinary skill in the art will appreciate that the presence of exhaust gas in the intake air may lower the relative proportion or amount of oxygen available for combustion in the combustion chamber, in turn resulting in a lower flame and/or combustion temperature.

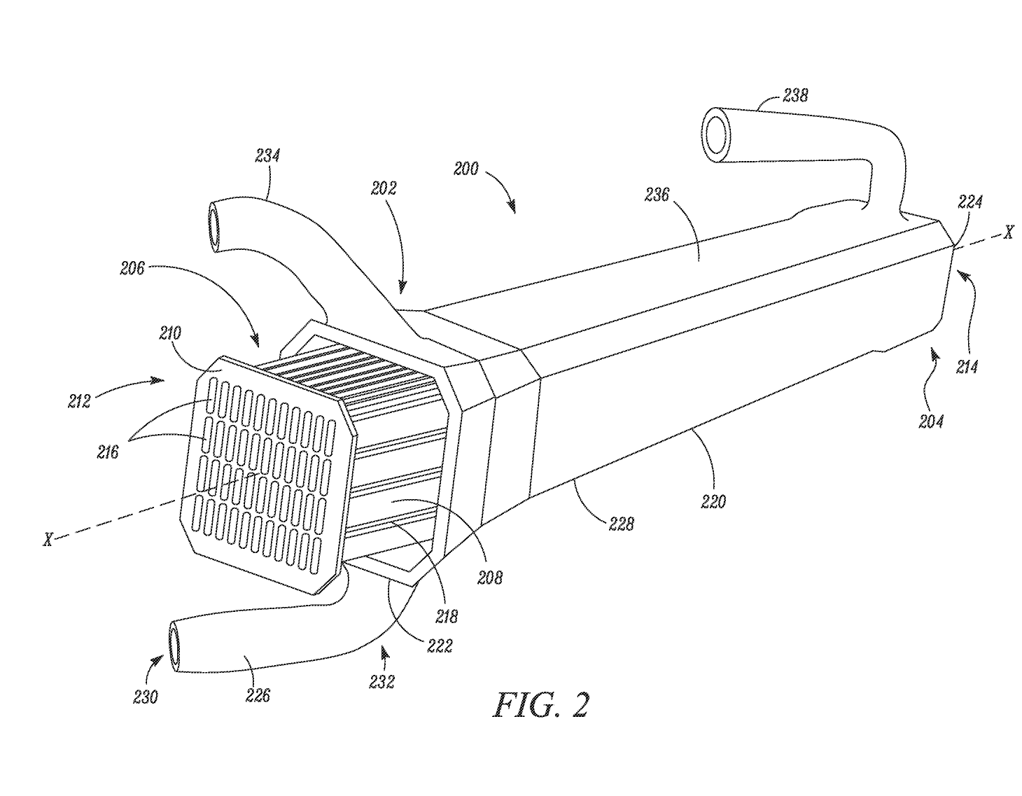

The present disclosure relates to a heat exchanger 200 for the EGR unit 126. A perspective view of the heat exchanger 200 is shown in FIG. 2. The heat exchanger 200 is configured to cool the exhaust gas flow. One of ordinary skill in the art will appreciate that the heat exchanger 200 disclosed herein is a common shell-and-tube design in which a plurality of hollow tubes conducting one medium is enclosed in a shell containing the other medium that flows around and past the tubes.

Referring to FIG. 2, the heat exchanger 200 may have an elongated configuration extending between an upstream face 202 and a downstream face 204, defining a longitudinal axis line X-X. The heat exchanger 200 has a tube core 206 including a plurality of exhaust gas tubes 208 extending from the upstream face 202 to the downstream face 204. The plurality of exhaust gas tubes 208 may be positioned in a parallel arrangement, wherein each of the plurality of exhaust gas tubes 208 may be spaced apart from each other. Further, the plurality of exhaust gas tubes 208 may be aligned parallel to the longitudinal axis X-X of the heat exchanger 200. The plurality of exhaust gas tubes 208 may be made from any suitable material such as a thin-walled metal like aluminum, steel, copper, or any other suitable material.

The plurality of exhaust gas tubes 208 may be fixed to an upstream header plate 210 at the upstream face 202 of the tube core 206. The plurality of exhaust gas tubes 208 may also be fixed to a corresponding downstream header plate (not shown), placed at the downstream face 204 of the tube core 206. The upstream header plate 210 and/or the downstream header plate may be configured to securely hold and maintain the position of the plurality of exhaust gas tubes 208 within the heat exchanger 200. In one embodiment, the plurality of exhaust gas tubes 208 may be mechanically fixed to the upstream header plate 210 and/or the downstream header plate. Alternatively, the plurality of exhaust gas tubes 208 may be integrated with the upstream header plate 210 and/or the downstream header plate. The upstream header plate 210 and the downstream header plate may be relatively thick, flat plates of a metallic material like steel or aluminum arranged perpendicular to the longitudinal axis X-X of the tube core 206.

Each of the plurality of exhaust gas tubes 208 may have a hollow configuration with an exhaust gas inlet 212 located at the upstream face 202 of the tube core 206 and a corresponding exhaust gas outlet 214 located at the downstream face 204 of the tube core 206. The exhaust gas outlet 214 may be provided downstream of the exhaust gas inlet 212 with relation to a direction of the exhaust gas flow. The exhaust gas inlet 212 may be configured to receive the exhaust gas flow into the plurality of exhaust gas tubes 208. In the illustrated embodiment, the exhaust gas inlets 212 and the exhaust gas outlets 214 are defined by a plurality of openings 216 provided on the upstream header plate 210 and the downstream header plate respectively. More specifically, the shape, size and dimensions of the openings 216 may be provided in cooperation with the dimensions of the exhaust gas tubes 208, in order to allow the exhaust gas flow to be received at the upstream face 212 of the tube core 206.

In one embodiment, the exhaust gas inlet 212 is in fluid communication with the exhaust manifold 116 and is configured to receive the exhaust gas flow leaving the exhaust manifold 116. Additionally, the exhaust gas outlet 214 may be configured to discharge the exhaust gas flow from the plurality of exhaust gas tubes 208. In one embodiment, the exhaust gas outlet 214 may be in fluid communication with the intake manifold 110 for discharging the relatively cooled exhaust gas flow back into the intake manifold 110.

The tube core 206 may further include a plurality of coolant channels 218 disposed between the plurality of exhaust gas tubes 208. Alternatively, the plurality of coolant channels 218 may be formed by the spaces created between the plurality of exhaust gas tubes 208. The plurality of coolant channels 218 may be configured to provide a coolant flow within the heat exchanger 200. It should be understood that a coolant loop may be formed by the plurality of coolant channels 218 disposed within the heat exchanger 200, in order to cool the exhaust gas flow. Accordingly, the plurality of coolant channels 218 may be disposed in such a manner so that a direction of the coolant flow within the heat exchanger 200 may be substantially parallel to the direction of the exhaust gas flow inside the tube core 206. In one embodiment, the tube core 206 may be disposed in a hollow outer housing or core shell 220. The core shell 220 may extend between a first rim 222 and an opposite second rim 224. The first and second rims 222, 224 may be disposed over and around the tube core 206 in order to retain the coolant flow within the plurality of coolant channels 218. Referring to FIG. 2, the core shell 220 may have a substantially rectangular configuration. It should be noted that parameters like shape, dimensions, size and material used to form the core shell 220 may vary based on the application.

A coolant inlet line 226 may be provided on the heat exchanger 200 and connected to the plurality of coolant channels 218. The coolant inlet line 226 may be integrated with the core shell 220. Alternatively, any suitable type of connection such as a hose barb, a threaded hose fitting, or a more complex connection such as a quick-release fitting, or a permanent connection such as done by welding or brazing may be utilized for connecting the coolant inlet line 226 to the plurality of coolant channels 218. The coolant inlet line 226 may have a hollow tube like structure through which the coolant may flow. The coolant inlet line 226 may include a flexible hose made of any suitable material. The coolant inlet line 226 may be configured to introduce the coolant flow into the plurality of coolant channels 218.

The coolant inlet line 226 may be positioned proximate to the exhaust gas inlet 212. It should be noted that the proximity in the positioning of the coolant inlet line 226 with respect to the exhaust gas inlet 212 may be such that the coolant flow is introduced at the upstream face 202 of the tube core 206. Accordingly, in one embodiment, the coolant inlet line 226 may be positioned in a first quarter section of the tube core 206. The first quarter section of the tube core 206 may include a length of the tube core 206 extending from the upstream face 202 to one fourth of the length of the tube core 206 adjacent to the upstream face 202. In the illustrated embodiment, the coolant inlet line 226 is provided along a first side 228 of the upstream face 202 of the tube core 206. In another embodiment, a number of additional coolant inlet lines (not shown in figures) may be provided along the length of the tube core 206.

In the illustrated embodiment, the coolant inlet line 226 has a first end 230 and a second end 232. The coolant inlet line 226 resembles a tube oriented parallel to the longitudinal axis X-X of the tube core 206 and progressively bending in an upward direction to connect with the tube core 206. The first end 230 of the coolant inlet line 226 has a substantially circular cross sectional area. The cross sectional area of the second end 232 of the coolant inlet line 226 is relatively elongated in order to spread over the first side 228 of the upstream face 202 of the tube core 206. A person of ordinary skill in the art will appreciate that the positioning, orientation, diameter and material used to form the coolant inlet line 226 may vary without any limitation. In one embodiment, a valve (not shown) may be associated with the coolant inlet line 226. The valve may be configured to control a volume of the coolant flow being introduced via the coolant inlet line 226 into the plurality of coolant channels 218. The valve may include any known flow control device known in art and may be actuated hydraulically, mechanically or electronically based on the application.

In the present disclosure, a first coolant outlet line 234 may be connected to the plurality of coolant channels 218. The first coolant outlet line 234 may be disposed in relation to the coolant inlet line 226 and may be positioned in such a manner so as to draw in at least a portion of the coolant flow which is introduced by the coolant inlet line 226 across the upstream face 202 of the tube core 206. In one embodiment, the first coolant outlet line 234 may be disposed proximate to the upstream face 202 of the tube sore 206 such that the first coolant outlet line 234 may be positioned in the first quarter section of the tube core 206.

In one embodiment, as shown in the accompanying figures, the first coolant outlet line 234 may be disposed along a second side 236 of the upstream face 202, the second side 236 opposing the first side 228 containing the coolant inlet line 226. This arrangement may facilitate in the drawing of the coolant flow across the upstream face 202 of the tube core 206. Moreover, the arrangement of the coolant inlet line 226 and the first coolant outlet line 234 with respect to the upstream face 202 may allow for a more uniform distribution of the coolant flow across the upstream face 202 of the tube core 206.

The positioning of the first coolant outlet line 234 described herein is exemplary. The first coolant outlet line 234 may also be placed in other locations. For example, in one situation in which the tube core 206 has a substantially circular cross sectional area, the first coolant outlet line 234 may be disposed diametrically opposite the coolant inlet line 226. In another exemplary situation, in case of a substantially rectangular cross sectional area of the tube core 206, the first coolant outlet line 234 may be located adjacent to the side containing the coolant inlet line 226.

Further, parameters like a diameter of the first coolant outlet line 234, length, material used to form the first coolant outlet line 234, cross sectional area, orientation, and the like may vary based on the application. It should be noted that based on the diameter of the first coolant outlet line 234 a volume of the coolant flow drawn into the first coolant outlet line 234 may be varied. For example, a relatively large diameter of the first coolant outlet line 234 may facilitate in the drawing of a larger volume of the coolant flow into the first coolant outlet line 234.

In the illustrated embodiment, the first coolant outlet line 234 has a substantially oval cross section along the second side 236 opposing the first side 228 containing the coolant inlet line 226, in such a manner that the first coolant outlet line 234 is positioned relatively above the coolant inlet line 226. A person of ordinary skill in the art will appreciate that coolant flow entering the coolant inlet line 226 may have a pressurized flow causing at least the portion of the coolant flow to be drawn across the upstream face 202 and into the first coolant outlet line 234. In the given embodiment, approximately 50% of the volume of the coolant flow introduced into the tube core 206 via the coolant inlet line 226 is drawn across the upstream face 202 and into the first coolant outlet line 234.

In one embodiment, a first valve (not shown) may be associated with the first coolant outlet line 234 in order to control the volume of the coolant flow drawn into the first coolant outlet line 234. The first valve may be any known flow control device known in the art. For example, a butterfly valve, a pressure actuated valve, a check valve, and so on. Further, the first valve may be controlled in a variety of ways, for example, hydraulically, mechanically, electronically, and the like.

A person of ordinary skill in the art will appreciate that the upstream face 202 of the tube core 206 is configured to receive relatively heated exhaust gas flow through the exhaust gas inlet 212 located at the upstream face 202. As the exhaust gas may flow towards the downstream face 204 of the tube core 206, a significant drop in temperature of the exhaust gas flow may be brought about by heat exchange with coolant flowing in the surrounding plurality of coolant channels 218. Accordingly, thermal stress experienced at the upstream face 202 of the tube core 206 may be relatively more than that experienced downstream of the tube core 206 with relation to the direction of the exhaust gas flow. Accordingly, in the present disclosure the first coolant outlet line 234 is positioned in the first quarter section of the tube core 206 in order to allow the coolant flow to be drawn from that section of the heat exchanger 200 which receives the relatively heated exhaust gas flow.

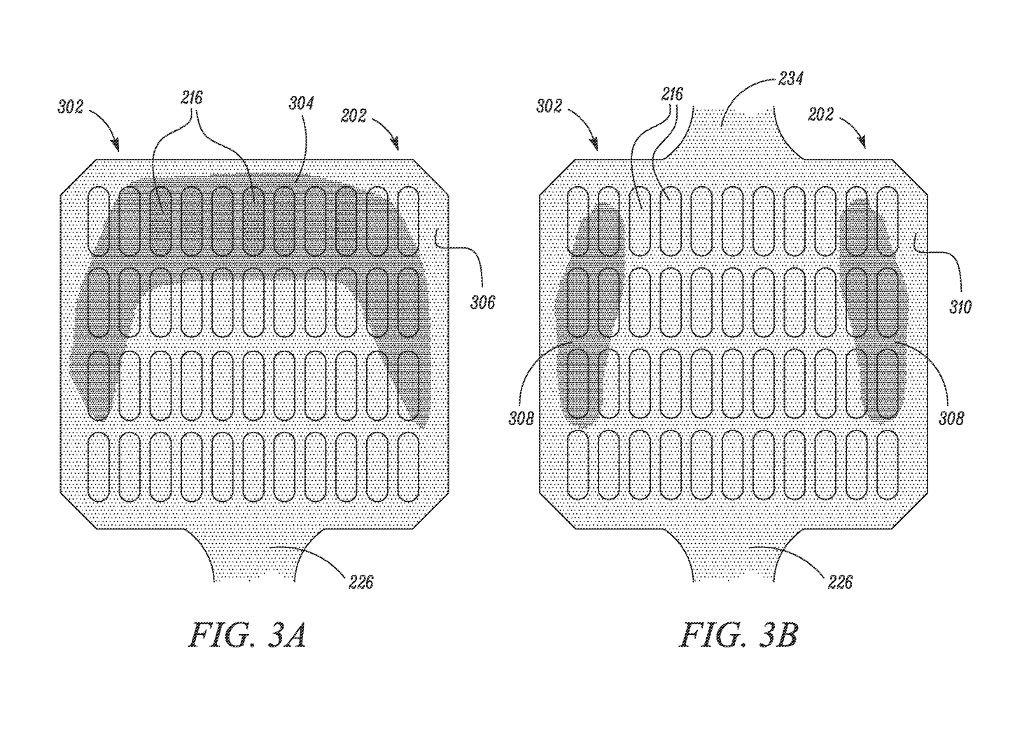

FIGS. 3A and 3B are schematic representations of variations in a thermal pattern produced at the upstream face 202 of the heat exchanger 200 corresponding to a design of the heat exchanger 200 wherein the first coolant outlet line 234 is absent and present respectively. It should be noted that FIG. 3A is a design known in the art and has been included on an illustrative basis merely for the purpose of comparison with the present disclosure.

As shown in FIG. 3A, a significant amount of thermal stress (shown by heavy shading in the accompanying figures) may be experienced towards an upper section 302 of the upstream face 202 of the tube core 206, in situation wherein the first coolant outlet line 234 is absent from the heat exchanger 200. More specifically, region 304 may have a temperature relatively higher than a surrounding region 306. This may be attributed to the fact that in the given situation, the pressurized coolant flow introduced into the plurality of coolant channels 218 via the coolant inlet line 226 may be directed along the longitudinal axis X-X of the tube core 206 towards the downstream face 204. As result of non-uniform distribution of the coolant flow across the upstream face 202, relatively high thermal stress may be experienced at the upstream face 202 of the tube core 206. The high thermal stress experienced at the upstream face 202 may in turn lead to failure of the heat exchanger 200.

In contrast, the shading shown in FIG. 3B is indicative of the thermal stress experienced at the upstream face 202 of the tube core 206 when the first coolant outlet line 234 is present as part of the heat exchanger 200. Regions 308 may be at a relatively higher temperature than a surrounding region 310. As explained earlier, the first coolant outlet line 234 is configured to draw at least the portion of the coolant flow across the upstream face 202 and into the first coolant outlet line 234, causing a comparatively uniform distribution of the coolant flow across the upstream face 202. The uniform distribution of the coolant flow across the upstream face 202 of the tube core 206 may lead to reduced peak temperatures and comparatively uniform temperature distribution at the upstream face 202, causing a significant reduction in the thermal stress experienced at the upstream face 202 of the tube core 206. It should be noted that the temperature experienced in the regions 308, 310 in FIG. 3B are comparatively lower than the temperatures experienced in the regions 304, 306, due to an overall reduction in peak temperature experienced at the upstream face 202 by the introduction of the first coolant outlet line 234. Also, as is visible from the shape and area of the region 304 as compared to the regions 308, the temperature distribution in FIG. 3B can be seen to be more uniform than that shown in FIG. 3A.

Referring to FIG. 2, a second coolant outlet line 238 may be connected to the plurality of coolant channels 218. The second coolant outlet line 238 may be provided downstream of the first coolant outlet line 234 with relation to the direction of the coolant flow. The second coolant outlet line 238 may be configured to discharge a remaining portion of the coolant flow from the plurality of coolant channels 218. The remaining portion of the coolant flow may include that portion of the coolant flow which was not drawn out of the first coolant outlet line 234. The second coolant outlet line 238 may be disposed near the downstream face 204 of the tube core 206, proximate to the exhaust gas outlet 214. In one embodiment, the second coolant outlet line 238 may be positioned in a half section of the tube core 206. The half section of the tube core 206 defined herein refers to anywhere between midway of the length of the tube core 206 and the downstream face 204 of the tube core 206. The positioning of the second coolant outlet line 238 in the half section of the tube core 206 which is near the exhaust gas outlet 214 may allow the remaining coolant to flow through the length of the heat exchanger 200, perform heat exchange with the exhaust gas flowing through the heat exchanger 200 and then drain out of the tube core 206. One of ordinary skill in the art will appreciate that the coolant flow leaving the second coolant outlet line 238 may be relatively warm due to heat exchange with the exhaust gas flow. The coolant flow leaving the second coolant outlet 238 may be at a reduced pressure as compared to the coolant flow being discharged from the first coolant outlet line 234.

As described earlier in connection with the first coolant outlet line 234, parameters like a diameter, length, dimensions, position and orientation of the second coolant outlet line 238 may vary. In the illustrated embodiment, the second coolant outlet line 238 is provided on the same surface of the tube core 206 containing the first coolant outlet line 234. The second coolant outlet line 238 is located at the downstream face 204 of the tube core 206. The second coolant outlet line 238 extends in the upward direction and further includes a 90° degree bend, such that the second coolant outlet line 238 may align itself with the longitudinal axis X-X of the tube core 206. In the given embodiment, approximately 50% of the volume of the coolant flow which was not drawn into the first coolant outlet line 234, may be discharged through the second coolant outlet line 238. The numerical values related to the volume of the coolant flow provided herein are merely exemplary. The volume of the coolant flow drawn out of the first and second coolant outlet lines 234, 238 may be adjusted based on the system requirements. In one embodiment, a number of additional second coolant outlet lines (not shown) may be provided on the heat exchanger 200. Further, the second coolant outlet line 238 may be fluidly connected to the engine 102.

One of ordinary skill in the art will appreciate that additional components not described herein may also be included in the system. For example, an exhaust gas inlet diffuser and an exhaust gas exit diffuser may be included within the heat exchanger 200 for directing the exhaust gas flow from the upstream face 202 to the downstream face 204 of the tube core 206. Also, a number of ports may be provided for venting of air during filling of the coolant. The exhaust gas tubes 208 may have features to enhance heat transfer such as fins, dimples, and so on. Additionally, the embodiment of the heat exchanger 200 described herein is a single pass design in which the two conducting mediums make a single pass through the heat exchanger 200. The disclosure may also be applicable to a multipass arrangement in which the conducting mediums are directed to make multiple passes through the heat exchanger 200 without deviating from the scope of the present disclosure.

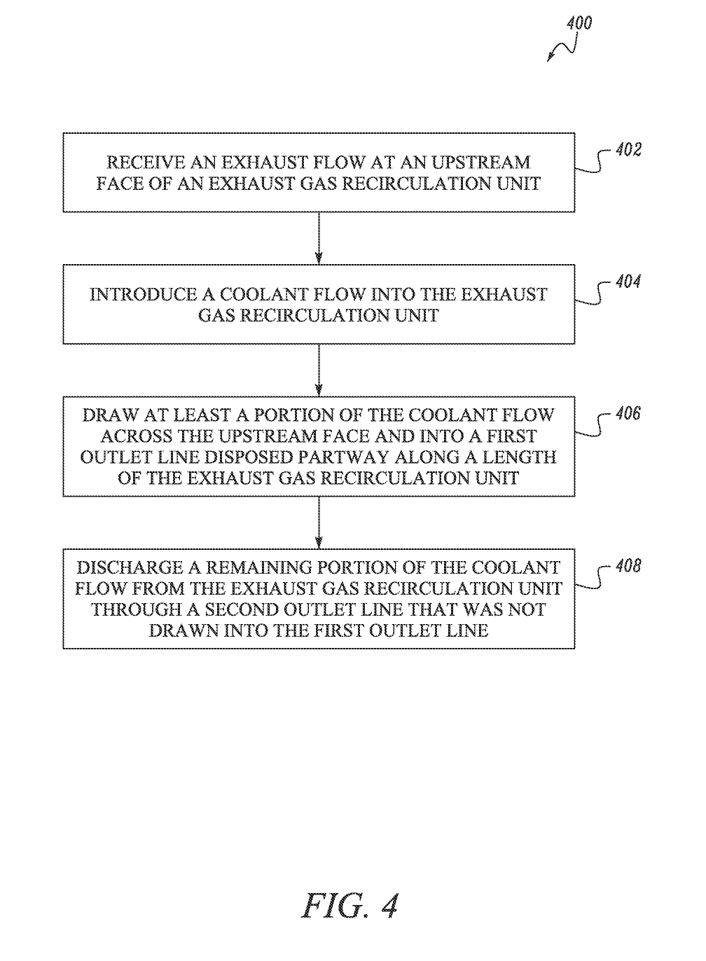

A method 400 for cooling the exhaust gas flow within the EGR unit 126 will be described in connection with FIG. 4.

### INDUSTRIAL APPLICABILITY

The present disclosure relates to providing multiple coolant outlet lines for the single coolant loop which is configured to cool the exhaust gas flow. More specifically, the disclosure provides the first coolant outlet line disposed proximate to the upstream face and in relation to the coolant inlet line. The first coolant outlet line is disposed in such a manner that it is configured to draw at least the portion of the coolant flow across the upstream face and into the first coolant outlet line.

The design of the heat exchanger described herein provides an improved heat distribution at the upstream face of the EGR unit particularly in an area around the exhaust gas inlet. The coolant flow drawn across the upstream face may result in the uniform coolant flow distribution, in turn leading to reduction in the peak temperatures at the upstream face. As a result, failures associated with the heat exchanger for the EGR unit may be considerably reduced. For example, generation of hot spots and/or cracks on the upstream face may be prevented. Moreover, the heat exchanger may have a robust design with reduced stress on the plurality of coolant channels during operation, in turn leading to an improved life of the heat exchanger.

At step 402, the exhaust gas flow may be received at the upstream face 202 of the EGR unit 126. In one embodiment, the exhaust gas flow may be received into the plurality of exhaust gas tubes 208 from the exhaust manifold 116 associated with the engine 102. The exhaust gas may flow from the upstream face 202, along the longitudinal axis X-X of the tube core 206, towards the downstream face 204. At step 404, the coolant flow may be introduced into the EGR unit 126 via the coolant inlet line 226. At step 406, at least the portion of the coolant flow may be drawn across the upstream face 202 and into the first coolant outlet line 234. As described earlier, the first coolant outlet line 234 may be positioned partway along the length of the tube core 206, and more specifically in the first quarter section of the tube core 206. In one embodiment, the volume of the coolant flow drawn into the first coolant outlet line 234 may be based on a variety of parameters like the diameter of the first coolant outlet line 234, the position of the first coolant outlet line 234, the actuation of the first valve associated with the first coolant outlet line 234, and so on.

The remaining portion of the coolant flow that was not drawn into the first coolant outlet line 234 may flow along the longitudinal axis X-X of the heat exchanger 200, towards the downstream face 202 of the tube core 206. More particularly, the remaining coolant may flow through the plurality of coolant channels 218 in the direction substantially parallel to the direction of the exhaust gas flow within the heat exchanger 200. Accordingly, heat exchange may take place between the coolant and the exhaust gas, resulting in the cooling of the exhaust gas flow. Thereafter, at step 408, the remaining portion of the coolant flow may be discharged via the second coolant outlet line 238 disposed at the downstream face 204 of the tube core 206. In one embodiment, the exhaust gas flow may be discharged from the exhaust gas outlet 214 present at the downstream face 204. This relatively cooled exhaust gas flow may be received into the intake manifold 110 associated with the engine 102. In another embodiment, the coolant flow leaving the first coolant outlet line 234 and/or the second coolant outlet line 238 may be recirculated back into the engine 102.

It should be noted that the coolant loop described herein for the cooling of the EGR unit 126 within the heat exchanger 200 may be considered either as an independent cooling circuit or as part of the coolant system 122 associated with the engine 102. One of ordinary skill in the art will appreciate that the present disclosure may be utilized or applied to any parallel flow shell and tube heat exchanger exhibiting significant thermal stress at an inlet face of the heat exchanger due to non-uniform flow distribution of the coolant.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A heat exchanger for an exhaust gas recirculation unit, the heat exchanger comprising:
a tube core including a plurality of exhaust gas tubes extending from an upstream face to a downstream face and a plurality of coolant channels disposed between the plurality of exhaust gas tubes;
a coolant inlet line connected to the plurality of coolant channels and disposed about at least a portion of the tube core proximate the upstream face;
a first coolant outlet line connected to the plurality of coolant channels and disposed about at least a portion of the tube core proximate the upstream face, the first coolant outlet line configured to draw at least a portion of a coolant flow across the upstream face and into the first coolant outlet line; and
a second coolant outlet line connected to the plurality of coolant channels and disposed downstream of the first coolant outlet line with relation to a direction of the coolant flow, the second coolant outlet line configured to discharge a remaining portion of the coolant flow from the plurality of coolant channels that was not drawn out of the first coolant outlet line.

2. The heat exchanger of claim 1, wherein the tube core has a substantially rectangular cross section.

3. The heat exchanger of claim 2, wherein the first coolant outlet line is disposed along a side opposing a side containing the coolant inlet line.

4. The heat exchanger of claim 1, wherein a volume of the coolant flow drawn into the first coolant outlet line is based on at least one of a diameter of the first coolant outlet line and a position of the first coolant outlet line relative to the coolant inlet line.

5. The heat exchanger of claim 1 further comprising a valve associated with the first coolant outlet line, wherein an actuation of the valve is configured to control the volume of the coolant flow drawn into the first coolant outlet line.

6. The heat exchanger of claim 1, wherein the second coolant outlet line is disposed in a section of the tube core defined between a midway of the length of the tube core and the downstream face.

7. The heat exchanger of claim 1, wherein the coolant inlet line is disposed in a first quarter section of the tube core defined between the upstream face and one fourth of a length of the tube core adjacent to the upstream face.

8. The heat exchanger of claim 7, wherein the first coolant outlet line is disposed in the first quarter section.

9. An engine comprising:
an exhaust gas recirculation loop comprising:
an exhaust gas inlet in fluid communication with an exhaust manifold and provided at an upstream face of a tube core, the exhaust gas inlet configured to receive an exhaust gas flow into a plurality of exhaust gas tubes of the tube core; and
an exhaust gas outlet in fluid communication with an intake manifold and provided at a downstream face of the tube core and positioned downstream of the exhaust gas inlet with relation to a direction of the exhaust gas flow, the exhaust gas outlet configured to discharge the exhaust gas flow from the plurality of exhaust gas tubes; and
a single coolant loop comprising:
a coolant inlet line connected to a plurality of coolant channels disposed between the plurality of exhaust gas tubes, the coolant inlet line disposed about at least a portion of the tube core proximate the upstream face, the coolant inlet line configured to introduce a coolant flow into the plurality of coolant channels;
a first coolant outlet line connected to the plurality of coolant channels and disposed about at least a portion of the tube core proximate the upstream face, the first coolant outlet line configured to draw at least a portion of the coolant flow into the first coolant outlet line across the exhaust gas inlet; and
a second coolant outlet line connected to the plurality of coolant channels, the second coolant outlet line configured to discharge a remaining portion of the coolant flow from the plurality of coolant channels that was not drawn into the first coolant outlet line.

10. The engine of claim 9, wherein at least one of the first coolant outlet line and the second coolant outlet line is in fluid communication with the engine.

11. The engine of claim 9, wherein the coolant inlet line is in fluid communication with a radiator.

12. The engine of claim 9, wherein a volume of the coolant flow drawn into the first coolant outlet line is based on at least one of a diameter of the first coolant outlet line and a position of the first coolant outlet line relative to the coolant inlet line.

13. The engine of claim 9, wherein the coolant inlet line is disposed in a first quarter section of the tube core defined between the upstream face and one fourth of a length of the tube core adjacent to the upstream face.

14. The engine of claim 13, wherein the first coolant outlet line is disposed in the first quarter section.

15. The engine of claim 9, wherein the second coolant outlet line is disposed in a half section of the tube core defined between midway of the length of the tube core and the downstream face.

16. A method for cooling an exhaust gas flow in an exhaust gas recirculation unit, the method comprising:
receiving the exhaust gas flow at an upstream face of the exhaust gas recirculation unit;
introducing a coolant flow into the exhaust gas recirculation unit;
drawing at least a portion of the coolant flow across the upstream face and into a first coolant outlet line disposed partway along a length of the exhaust gas recirculation unit; and
discharging a remaining portion of the coolant flow from the exhaust gas recirculation unit through a second coolant outlet line that was not drawn into the first coolant outlet line.

17. The method of claim 16 further comprising controlling a volume of the coolant flow drawn across the upstream face, wherein the controlling is based on at least one of a diameter of the first coolant outlet line, a position of the first coolant outlet line and an actuation of a valve associated with the first coolant outlet line.

18. The method of claim 16 further comprising heat exchange between the coolant flow and the exhaust gas flow within the exhaust gas recirculation unit.

19. The method of claim 16 further comprising discharging the exhaust gas flow from a downstream face of the exhaust gas recirculation unit.

20. The method of claim 16 further comprising receiving the discharged exhaust gas flow into an intake manifold associated with an engine.
